(19) United States
(12) Patent Application Publication
(10) Pub. No.: US 2008/0313285 A1
(43) Pub. Date: Dec. 18, 2008

(54) POST TRANSIT SPAM FILTERING

(75) Inventor: Mihai Costea, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/763,256

(22) Filed: Jun. 14, 2007

(51) Int. Cl. G06F 15/16

(52) U.S. Cl. 709/206

(57) ABSTRACT

A system filters for electronic messages received from recently identified sources of unsolicited spam. A database comprises information regarding electronic messages that were previously received. The information may comprise an identification of the source of the electronic message. A server is programmed to identify sources of unsolicited electronic messages and search the database for electronic messages previously received from the identified source. The server is programmed to attempt to remove the previously received electronic messages originating from the identified source of spam from users' electronic message boxes prior to being viewed by the intended recipients.

### BACKGROUND

Electronic messaging systems such as those for providing, for example, electronic mail and instant messaging, have become ubiquitous in modern society. Electronic messaging systems have been used for years in academic and corporate settings, and are now widely used in the individual consumer market. Indeed, electronic messaging has become so pervasive that it is quickly becoming a preferred means of communication for many corporations and individuals.

Widespread use of electronic messaging by consumers has attracted individuals and corporations that have adapted the medium as a marketing tool. Users of electronic messaging are frequently the target of unsolicited electronic messages, sometimes referred to as spam. For example, users of electronic mail typically receive numerous unsolicited marketing emails during the course of a single day. Similarly, it is common for users of text messaging and instant messaging systems to receive numerous unsolicited messages in a relatively brief period. Unsolicited electronic messages may be distracting and ultimately lead to a loss in productivity, especially when the unsolicited electronic messages are received in the quantities that have become typical.

### SUMMARY

In the subject matter described herein, a system provides automated filtering for unsolicited electronic messages. In a disclosed system, unsolicited electronic messages may be identified and filtered even after being received and delivered to a client device.

An illustrative system may comprise an information store or database comprising information regarding electronic messages that are received. The information that is stored and maintained for received electronic messages may vary, but may comprise, for example, information regarding the source of the electronic message and/or the contents of the electronic messages. An embodiment of the database may comprise, for example, any or all of the following: the address of the machine from which the particular message originated; the networking domain from which the particular electronic message originated; header information from the electronic message; all or part of the contents of the electronic message; and a digital fingerprint relating to the particular electronic message. The information may further comprise an identification of the location to which the particular electronic message was forwarded.

The illustrative system may further comprise one or more servers adapted to process incoming electronic messages. The servers may be adapted to receive electronic messages, check that the messages are not from known sources of unsolicited electronic messages, and forward electronic messages that are not identified as being from a source of unsolicited messages to an appropriate location for retrieval by the intended recipient. For example, as the electronic messages are received, they may be forwarded to the appropriate client device or user's mail box.

As the electronic messages are received, the server is adapted to store information relating to each received electronic message in the database. The servers may be adapted to store, for example, any or all of the following: the address of the machine from which the particular message originated; the networking domain from which the particular electronic message originated; header information from the electronic message; all or part of the contents of the electronic message; and a digital fingerprint relating to the particular electronic message.

The server is further adapted to monitor for sources of unsolicited electronic messages, i.e., spam. For example, in an embodiment, the server may be adapted to communicate with one or more services that track identified sources of unsolicited electronic messages. The server may also receive communications from individuals identifying particular sources of unsolicited electronic messages. Sources of unsolicited electronic messages may be identified, for example, by a network address, a network domain, or even the contents of the electronic message.

Upon identifying a new source of unsolicited electronic messages, the server searches the database of information relating to received electronic messages to determine whether any of the received electronic messages may have been received from the identified source of unsolicited messages. For example, if the source of unsolicited electronic messages is identified by a particular network address, the server may search its database for electronic messages that were received from the particular network address. In an embodiment, if the source of the unsolicited electronic messages is identified by a particular network domain, the server may search for electronic messages that were received from the particular network domain.

If the server identifies previously received electronic messages that were received from an identified source of unsolicited electronic messages, the server takes action to prevent the identified electronic messages from being presented to an addressed recipient. For example, in an embodiment, if the server identifies that an electronic message was received from an identified source of unsolicited electronic messages, the server may request that the particular electronic message be recalled or deleted from the particular user's email client, a particular device, and/or from an electronic message store on the server.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

The foregoing summary and the following additional description of the illustrative embodiments may be better understood when read in conjunction with the appended drawings. It is understood that potential embodiments of the disclosed systems and methods are not limited to those depicted.

FIG. 1 is a network diagram of an illustrative computing arrangement in which aspects of the subject matter described herein may be implemented.

FIG. 2 is a block diagram of functional components comprised in an illustrative server system.

FIG. 3 is a block diagram of functional components comprised in an illustrative client device.

FIG. 4 is a flow diagram of an illustrative process for receiving electronic messages.

FIG. 5 is a flow diagram of an illustrative process for filtering previously received messages.

FIG. 6 is a block diagram of an illustrative computing environment with which aspects of the subject matter described herein may be deployed.

### DETAILED DESCRIPTION OF ILLUSTRATIVE EMBODIMENTS

Overview

The subject matter disclosed herein is directed to systems and methods for providing automated filtering for unsolicited messages, and in particular, for automated filtering of electronic messages that were previously received and transmitted to recipients' message boxes.

An illustrative system may comprise a database that comprises information regarding electronic messages that have been received. The information in the database may comprise an indication of the source of the electronic message, e.g. a network address of the sender, and the current location of the message, e.g. the message box where the electronic message is stored.

An illustrative system may comprise a server that is adapted to receive electronic messages and record information in the database about the messages. The server forwards the electronic messages to the intended recipient's message store or mail box which may be located on a user's client device.

If a particular source of electronic messages is subsequently identified as a source of spam, the server searches the database to identify electronic messages previously received from the identified source. The server attempts to delete or recall electronic messages that were previously received from the newly identified source of unsolicited messages.

Thus, even after an unsolicited electronic message has been delivered to a user's message box, it is possible to identify the message as being unsolicited and prevent the unsolicited message from being retrieved, i.e. read, by the intended recipient.

The disclosed systems and methods may be implemented in commercial software and standard hardware. For example, in an embodiment of the disclosed systems and methods, the disclosed server functionality may be implemented in an email server, a unified messaging server, or other commercially available electronic message server software. Further, the server may be implemented on standard computing hardware and may communicate using established networking technology and protocols.

Example Computing Arrangement

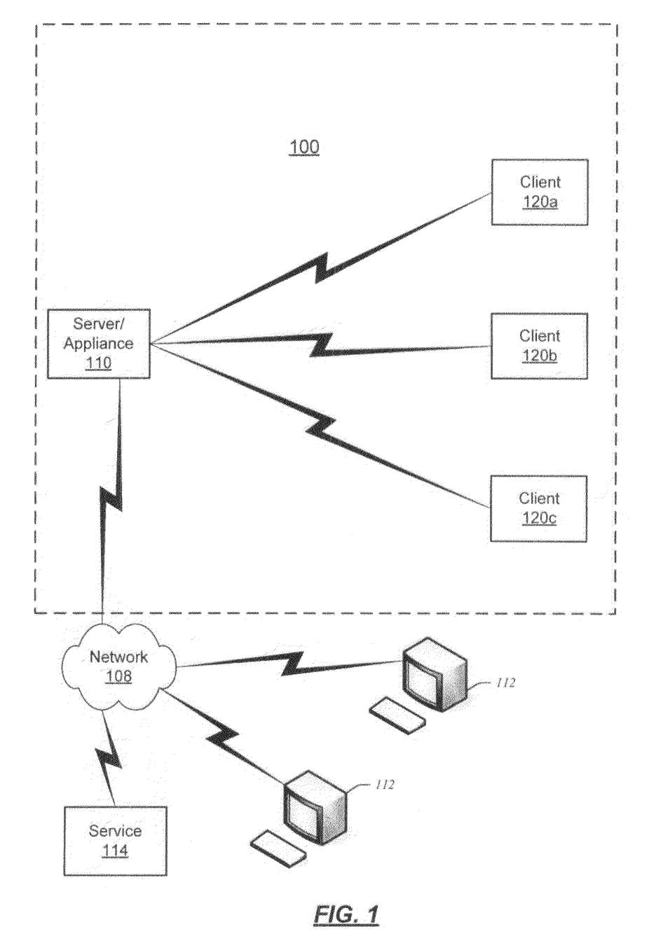

FIG. 1 illustrates an exemplary computing arrangement 100 suitable for providing filtering of electronic messages, and in particular, filtering of messages that were previously received and delivered to users message boxes. As shown, computing arrangement 100 is communicatively coupled with network 108. Network 108 is adapted to communicate electronic messages such as, for example, e-mails and/or instant messages, from computing devices 112 and may be any type of network suitable for the movement of electronic messages. Network 108 may comprise local area networks (LANs), wide area networks (WAN's), the Internet, or combinations thereof and may employ any suitable networking topology such as, for example, wireless, wireline, or combination thereof.

Server 110 comprises one or more computing systems that that are programmed with computer-readable instructions to operate as described herein to provide electronic message services. For example, server 110 may be a general purpose computing system with electronic message server software. Server 110 may also be an appliance device that is dedicated to providing electronic message services. Server 110 interfaces with network 108 to handle the receiving and sending of electronic messages. For example, server 110 may be adapted to be an email server and operate to receive emails from devices 112, as well as to forward email to devices 112.

Server 110 may also be adapted to communicate with services such as service 114 that are accessible via network 108. Service 114 may be, for example, a service that is adapted to compile listings of network locations that have been identified as sources of unsolicited electronic messages, i.e. spam. For example, service 11 may be a service such as that located at www.spamhaus.org on the World Wide Web (WWW) which provides information regarding known sources of unsolicited mail.

Server 110 is communicatively coupled with client devices 120a-c. Client devices 120a-c may be any devices that are suitable for sending and receiving electronic messages. For example, client devices 120a-c may be personal computers, personal digital assistants, phones, etc. Server 110 is adapted to forward electronic messages received from network 108 to devices 120a-c and to forward electronic messages generated at devices 120a-c to network 108. Client devices 120a-c may be communicatively coupled with server 110 via any network suitable for communicating electronic messages. For example, client devices 120a-c may be communicatively coupled to server 110 via networks such as, for local area networks (LANs), wide area networks (WAN's), the Internet, or combinations thereof and may employ any suitable networking topology such as, for example, wireless, wireline, or combination thereof.

In an exemplary embodiment, upon receipt of an electronic message, e.g. an email, server 110 may determine if the electronic message is from a known source of spam. If server 110 determines the email is not from a known source of spam, server 110 makes the electronic message available to the one of client devices 120a-c that corresponds to the intended recipient of the electronic message. Server 110 maintains a database of information about the electronic messages that it has received including, for example, the source of the electronic message. Server 110 monitors for newly identified sources of unsolicited electronic messages. For example, server 110 may communicate with service 114 that maintains a current listing of sources of unsolicited messages. If server 110 identifies a new source of unsolicited electronic messages, it searches the database to identify previously received messages from the identified source. Upon identifying previously received messages that originated from the newly identified source of spam, server 110 is adapted to take action to prevent the intended recipient from receiving the message from the identified source of spam. For example, server 110 may remove or request to remove the particular electronic message from the particular user's mail box.

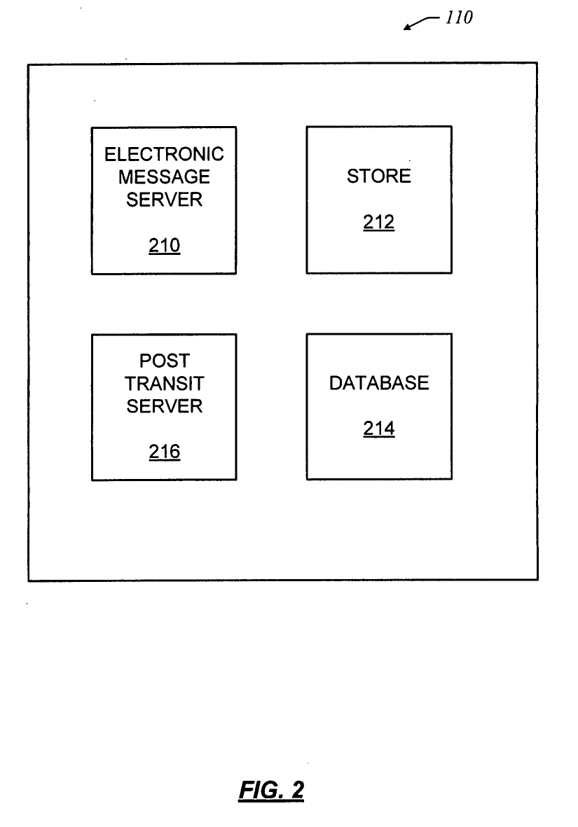

FIG. 2 is a block diagram of functional components that may be comprised in server 110. As shown, server 110 may comprise electronic message server 210. Electronic message server 210 operates to receive incoming electronic messages from network 108 and to send outgoing electronic messages that originated at clients 120a-c to network 108. Electronic message server 210 may be, for example, an email server and/or an instant messaging server. In an embodiment wherein electronic message server 210 comprises an email server, message server 210 may comprise software adapted to communicate using the standard email protocols such as, for example, simple mail transfer protocol (SMTP), post office protocol (POP), and internet mail access protocol (IMAP).

Server 110 may further comprise store 212. Store 212 is employed as a location to store electronic messages that are received via network 108. In an example embodiment, electronic messages may be stored temporarily until the messages are forwarded to the intended recipient's message box located on one of devices 120a-c. However, store 212 may operate as a permanent storage location for electronic messages as well. For example, electronic messages may be located in store 212 and client devices 120a-c may access server 110 to review electronic messages.

Sever 110 further comprises database 214. Database 214 comprises information regarding electronic mails that have been received. For example, database 214 may comprise for each electronic message information identifying the source of the message, the recipient of the message, and the present location of the electronic message. The information stored and maintained in database 214 for received electronic messages may vary, but may comprise, for example, any or all of the following: the address of the machine from which the particular message originated; the networking domain from which the particular electronic message originated; header information from the electronic message; all or part of the contents of the electronic message; and a digital fingerprint relating to the particular electronic message.

Server 110 further comprises post-transit server 216. Post-transit server 216 is adapted to identify new sources of unsolicited electronic messages and to retrieve and/or delete electronic messages that were previously received from newly identified spam sources. For example, post-transit server 216 may be adapted to communicate with an external service such as, for example, www.spamhaus.org that maintains a current list of known sources of unsolicited messages. Post-transit sever 216 may periodically contact the external service to receive updates regarding newly identified sources of unsolicited messages. Post-transit server 216 may be adapted to receive updates regarding potential sources of spam from other sources as well. For example, server 216 may be adapted to receive messages from system users identifying sources of spam.

Upon receiving an identification of a new source of unsolicited electronic messages, post-transit server 216 searches database 212 for electronic messages that were previously received from the identified source. For electronic messages received from the identified source, post-transit server 216 attempts to prevent the electronic message from being reviewed by the addressed recipient. This may involve deleting the electronic message from the appropriate in-box in store 212 and/or transmitting a request to the appropriate device 120a-c to recall and/or delete the electronic message from the particular device.

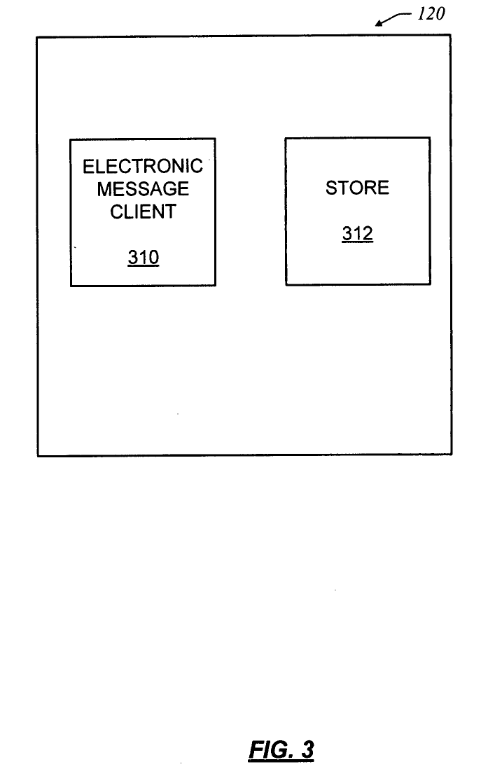

FIG. 3 depicts functional components of an electronic message system comprised on client devices 120a-c. Client devices 120a-c may comprise electronic message client 310 that is adapted to communicate with electronic message server 210 to send and receive electronic messages. Electronic message client 310 may be, for example, a client adapted to handle email and/or instant messages. In an embodiment wherein electronic message client 310 is adapted to send and receive emails, electronic message client 310 may comprise POP and/or IMAP client software.

Client devices 120a-c may further comprise store 312 for storing received electronic messages. In an embodiment adapted to send and receive emails, store 312 may be adapted to operate as a message box for the particular user/device.

Electronic Message Filter Method

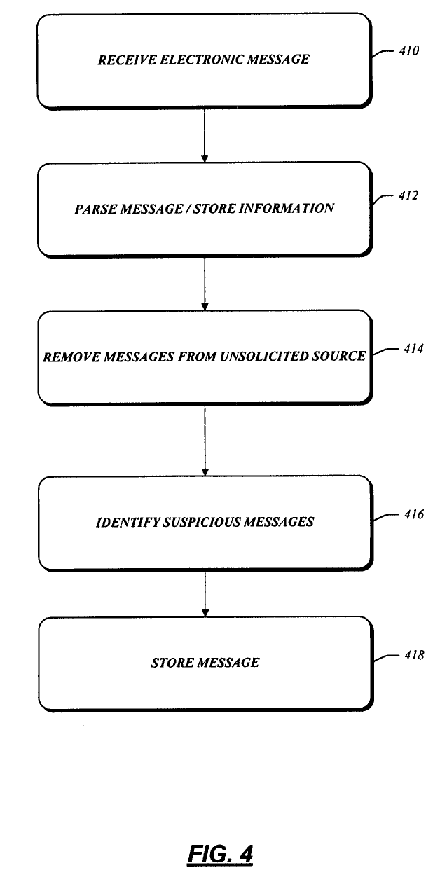

FIG. 4 is a flow diagram of an illustrative process for receiving electronic messages. At step 410, an electronic message is received at server 110 from network 108. Message server 210 is adapted to process the electronic message. At step 412, message server 412 may be adapted to parse and store information about the received electronic message in database 214. In particular, message server 412 may be adapted to parse a received electronic message to identify the source of the electronic message and the intended recipient. In an embodiment, message server functionality 210 may be adapted to parse the electronic message and store the following in database 214: the address of the machine from which the particular message originated; the networking domain from which the particular electronic message originated; header information from the electronic message; all or part of the contents of the electronic message; and a digital fingerprint relating to the particular electronic message. The information may further comprise an identification of the location to which the particular electronic message is forwarded.

At step 414, electronic message server 210 may filter messages that are received from known sources of unsolicited messages. Thus, if server 110 is aware that a particular message was received from a known source of spam, it might filter it when it is received and prevent it from ever being delivered to the intended recipient.

At step 416, in an illustrative embodiment, even if the source of an electronic message cannot be identified with certainty as originating from a known source of spam electronic message server 210 may be adapted to identify messages that are suspected of being unsolicited spam. For example, server functionality 210 may identify an electronic message as being suspected of being spam if the electronic message is one of many others received from the same network address or domain.

At step 418, electronic message server 210 stores the received electronic message. For example, the message may be stored in store 212. The message may also be downloaded to the appropriate device 120a-c corresponding to the intended recipient where it may be stored in the individual's message box.

In an embodiment wherein messages are identified as being suspected of being spam, electronic message server functionality 210 may delay delivering the electronic message to a client device 120a-c. After a period of time has passed and there has been no indication that the source of the suspected spam is in fact a spam source, electronic message server functionality 210 may deliver the suspicious message to the intended recipient's in box.

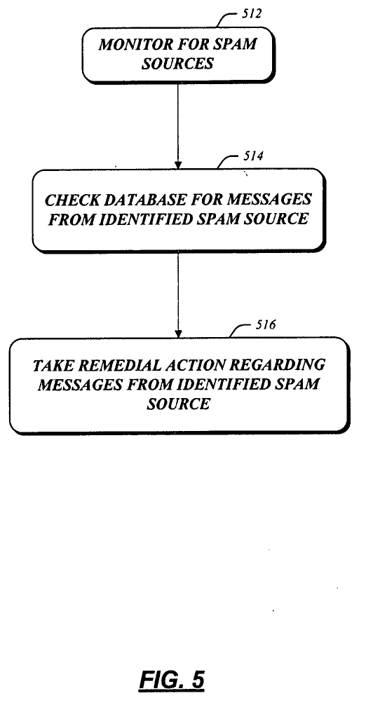

FIG. 5 is a flow diagram of an illustrative process for filtering previously received electronic messages. As shown, at step 512, post-transit server 216 monitors for identification of known sources of unsolicited messages. This may include, for example, communicating over network 108 with one or more services 114 that maintain a current list of sources of unsolicited mail. Post-transit server 216 may periodically request updated information from service 114. Alternatively, post-transit server 216 may have been previously registered to automatically receive updates. Sources of unsolicited electronic messages may be identified, for example, by a network address such as an IP address, by a domain address, or any other information that is reasonably able to identify an electronic message as having originated from a particular source. For example, a source of unsolicited electronic messages may be identified, for example, by the contents of electronic message including the presence of a particular uniform resource locator or email address in the body of the electronic message.

Upon receiving an identification of a source of the electronic mail, at step 514, post-transit server 216 searches database 214 for previously received electronic messages that were received from the identified source of unsolicited messages. For example, post-transit server 216 may search for electronic messages that were received from a particular network address or network domain that has been identified as a source of unsolicited messages. Post-transit server 216 may also search for messages that contained a particular piece of content such as, for example, a URL or email address.

At step 516, post-transit server 216 takes action to prevent messages previously received from an identified source of unsolicited messages from being reviewed by the intended recipient. In an embodiment, post transit server 216 may, for example, delete the messages from the identified source from store 212. Post transit server 216 may request that the identified message be removed or delivered from an in box located on devices 120a-c. For example, post transit server 216 may issue a command to the appropriate device 120a-c recalling a particular message from the inbox located on the device. The command may identify the particular message and direct that the message be removed. Alternatively, the command may identify the identified source of spam and request that the client identify and remove all emails from the source. In an embodiment wherein message server 210 may have delayed delivery of suspected spam, post-transit server 216 may be able to delete the electronic message before it is ever made available to the intended recipient.

Example Computing Environment

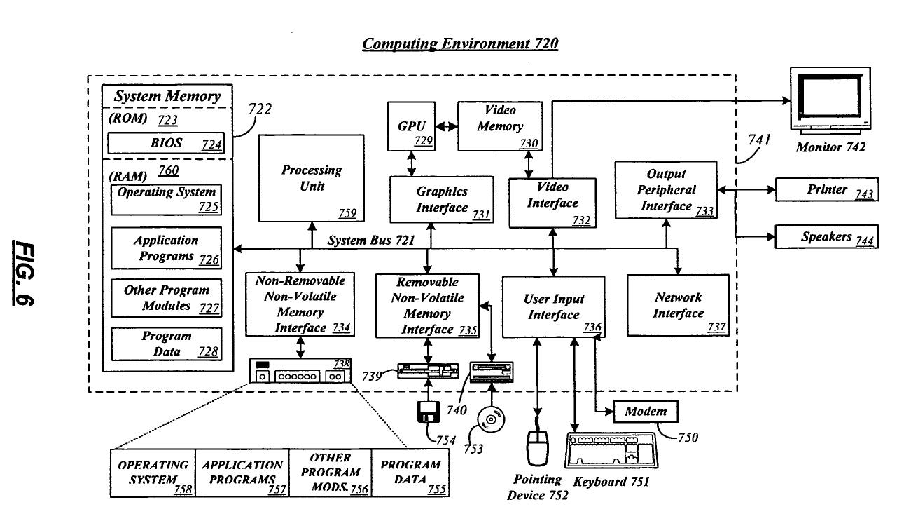

FIG. 6 depicts an example computing environment 720 that may be used in an exemplary computing arrangement 100. Example computing environment 720 may be used in a number of ways to implement the disclosed methods for filtering of electronic messages as described herein. For example, computing environment 720 may operate as server 110 and/or as devices 120a-c to provide electronic message filtering as described herein.

Computing environment 720 is only one example of a suitable computing environment and is not intended to suggest any limitation as to the scope of use or functionality of the subject matter disclosed herein. Neither should the computing environment 720 be interpreted as having any dependency or requirement relating to any one or combination of components illustrated in the example operating environment 720.

Aspects of the subject matter described herein are operational with numerous other general purpose or special purpose computing system environments or configurations. Examples of well known computing systems, environments, and/or configurations that may be suitable for use with the subject matter described herein include, but are not limited to, personal computers, server computers, hand-held or laptop devices, portable media devices, multiprocessor systems, microprocessor-based systems, set top boxes, programmable consumer electronics, network PCs, minicomputers, mainframe computers, distributed computing environments that include any of the above systems or devices, and the like.

An example system for implementing aspects of the subject matter described herein includes a general purpose computing device in the form of a computer 741. Components of computer 741 may include, but are not limited to, a processing unit 759, a system memory 722, and a system bus 721 that couples various system components including the system memory to the processing unit 759. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 741 typically includes a variety of computer readable media. Computer readable media can be any available media that can be accessed by computer 741 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 741. Communication media typically embodies computer readable instructions, data structures, program modules or other data in a modulated data signal such as a carrier wave or other transport mechanism and includes any information delivery media. The term “modulated data signal” includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 722 includes computer storage media in the form of volatile and/or nonvolatile memory such as read only memory (ROM) 723 and random access memory (RAM) 760. A basic input/output system 724 (BIOS), containing the basic routines that help to transfer information between elements within computer 741, such as during start-up, is typically stored in ROM 723. RAM 760 typically contains data and/or program modules that are immediately accessible to and/or presently being operated on by processing unit 759. By way of example, and not limitation, FIG. 6 illustrates operating system 725, application programs 726, other program modules 727, and program data 728.

Computer 741 may also include other removable/non-removable, volatile/nonvolatile computer storage media. By way of example only, FIG. 6 illustrates a hard disk drive 738 that reads from or writes to non-removable, nonvolatile magnetic media, a magnetic disk drive 739 that reads from or writes to a removable, nonvolatile magnetic disk 754, and an optical disk drive 740 that reads from or writes to a removable, nonvolatile optical disk 753 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 738 is typically connected to the system bus 721 through a non-removable memory interface such as interface 734, and magnetic disk drive 739 and optical disk drive 740 are typically connected to the system bus 721 by a removable memory interface, such as interface 735.

The drives and their associated computer storage media discussed above and illustrated in FIG. 6, provide storage of computer readable instructions, data structures, program modules and other data for the computer 741. In FIG. 6, for example, hard disk drive 738 is illustrated as storing operating system 758, application programs 757, other program modules 756, and program data 755. Note that these components can either be the same as or different from operating system 725, application programs 726, other program modules 727, and program data 728. Operating system 758, application programs 757, other program modules 756, and program data 755 are given different numbers here to illustrate that, at a minimum, they are different copies. A user may enter commands and information into the computer 741 through input devices such as a keyboard 751 and pointing device 752, commonly referred to as a mouse, trackball or touch pad. Other input devices (not shown) may include a microphone, joystick, game pad, satellite dish, scanner, or the like. These and other input devices are often connected to the processing unit 759 through a user input interface 736 that is coupled to the system bus, but may be connected by other interface and bus structures, such as a parallel port, game port or a universal serial bus (USB). A monitor 742 or other type of display device is also connected to the system bus 721 via an interface, such as a video interface 732. In addition to the monitor, computers may also include other peripheral output devices such as speakers 744 and printer 743, which may be connected through an output peripheral interface 733.

Thus, a system for providing post transmission filtering of unsolicited messages has been disclosed. Even after an unsolicited electronic message has been delivered to a user's message box, it is possible to identify the message as being unsolicited and prevent the unsolicited message from being retrieved, i.e. read, by the intended recipient.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed:

1. A method of processing electronic messages implemented at least in part in a computing system, comprising:
receiving electronic messages;
maintaining information relating to the received electronic messages;
monitoring for sources of unsolicited electronic messages;
searching the information relating to the received electronic messages for electronic messages from an identified source of unsolicited electronic messages; and
taking action to attempt to prevent received electronic messages from the identified source of unsolicited messages from being presented to an addressed recipient.

2. The method of claim 1, wherein receiving electronic messages comprises receiving electronic mail.

3. The method of claim 1, wherein receiving electronic messages comprises parsing electronic messages to identify a source for each electronic message.

4. The method of claim 1, wherein maintaining information relating to the electronic messages comprises maintaining a database comprising information regarding previously received electronic messages.

5. The method of claim 4, wherein maintaining a database comprising information regarding received electronic messages comprises maintaining addresses for the locations from which electronic messages were received.

6. The method of claim 5, wherein maintaining a database comprising information regarding received electronic messages comprises maintaining information from headers of received electronic messages.

7. The method of claim 5, wherein maintaining a database comprising information regarding previously received electronic messages comprises maintaining information regarding content of received electronic messages.

8. The method of claim 1, wherein monitoring for sources of unsolicited electronic messages comprises monitoring a database comprising information regarding sources of unsolicited electronic messages.

9. The method of claim 8, wherein monitoring a database comprising information regarding sources of unsolicited electronic messages comprises monitoring a database comprising addresses of sources of unsolicited electronic messages.

10. The method of claim 1, wherein searching the information relating to the received electronic messages for electronic messages from an identified source of unsolicited electronic messages comprises searching a database to identify electronic messages previously received from an identified address.

11. The method of claim 1, wherein searching the information relating to the received electronic messages for electronic messages from an identified source of unsolicited electronic messages comprises searching a database to identify previously received electronic messages comprising an identified uniform resource locator.

12. The method of claim 1, wherein taking action to attempt to prevent received electronic messages from the identified source of unsolicited electronic messages from being presented comprises removing a previously received electronic message received from the identified source from an electronic message box.

13. The method of claim 1, wherein taking action to attempt to prevent received electronic messages from the identified source of unsolicited electronic messages from being presented comprises transmitting a request to recall a previously forwarded electronic message received from the identified source.

14. The method of claim 1, further comprising:
identifying suspicious electronic messages;
delaying delivery of suspicious electronic messages;
wherein taking action to attempt to prevent received electronic messages from the identified source of unsolicited messages from being presented to an addressed recipient comprises not delivering an electronic message previously identified as a suspicious electronic message.

15. A computer-readable storage medium having stored thereon information comprising:
computer-executable instructions for receiving electronic messages;
computer-executable instructions for maintaining information relating to received electronic messages;
computer-executable instructions for determining electronic messages are not associated with an identified source of spam and delivering the electronic messages;
computer-executable instructions for re-evaluating previously received electronic messages to identify electronic messages received from an identified source of spam, and preventing identified electronic messages from being retrieved by intended recipients.

16. The computer-readable storage medium of claim 15, wherein said computer-executable instructions for re-evaluating previously received electronic messages comprises searching the information relating to received electronic messages to identify electronic messages from the identified source of unsolicited electronic messages.

17. The computer-readable storage medium of claim 15, further comprising computer executable instructions for delivering received electronic messages to client devices;
wherein said computer-executable instructions for preventing identified electronic messages from being retrieved by intended recipients comprises computer-executable instructions for requesting that an electronic message previously delivered to a client device be deleted.

18. A system for processing electronic messages, comprising:
a database comprising information regarding received electronic messages; and
a server comprising computer-readable instructions for performing the following:
receiving electronic messages;
updating said database with information relating to the electronic messages;
searching said database to identify previously received electronic messages received from a source of unsolicited electronic messages;
attempting to prevent an identified previously received electronic message from being presented to an intended recipient.

19. The system of claim 18, wherein the system comprises a spam appliance filter.

20. The system of claim 18, wherein said computer-readable instructions for attempting to prevent an identified previously received electronic message from being presented to an intended recipient comprises computer-readable instructions for requesting the electronic message to be deleted from a message box.
